(19) United States
(12) Patent Application Publication
(10) Pub. No.: US 2024/0383472 A1
(43) Pub. Date: Nov. 21, 2024

(54) ANIMAL CLASSIFICATION AND AVOIDANCE FOR AUTONOMOUS VEHICLES

(71) Applicant: GM Cruise Holdings LLC, San Francisco, CA (US)

(72) Inventors: Jennifer Devar McKnew, Petaluma, CA (US); Max Eunice, San Francisco, CA (US); Alexander Willem Gerrese, San Francisco, CA (US); Silas Reeves, San Francisco, CA (US)

(73) Assignee: GM Cruise Holdings LLC, San Francisco, CA (US)

(21) Appl. No.: 18/319,650

(22) Filed: May 18, 2023

(51) Int. Cl. B60W 30/095; B60Q 5/00; G06V 10/764; G06V 20/58; G06V 40/10; G08G 1/00; G08G 1/16

(52) U.S. Cl. CPC B60W 30/0956; B60Q 5/006; G06V 10/764; G06V 20/58; G06V 40/10; G08G 1/16; G08G 1/20; B60W 2554/402

(57) ABSTRACT

An autonomous vehicle (AV) detects an animal in its vicinity, classifies the detected animal, and selects an action to take based on the classification. The action may be selected to deter the animal away from a roadway along which the AV is traveling, or for the AV to avoid a collision or other negative encounter with the animal. The AV determines whether to proceed along the roadway, e.g., if the action has caused the animal to leave the roadway. The animal classification may be used to determine whether or not to drop off or pick up a user at a particular location near an animal.

### TECHNICAL FIELD OF THE DISCLOSURE

The present disclosure relates generally to interactions between vehicles and wildlife and, more specifically, to autonomous vehicle (AV) decisions and actions when AVs encounter animals.

### BACKGROUND

As autonomous operations expand out of urban areas and into more suburban or rural areas, the incidence and variety of wildlife encounters is expected to increase. When human drivers encounter wildlife, they may respond in a non-optimal way, e.g., by making a sudden stop, hitting an animal in the road, swerving off the road, or swerving into the path of another vehicle. With advanced sensor systems, AVs may be better able to detect an animal in or near a roadway. However, different animals behave in different ways, and it is challenging for AVs to operate around detected animals in a manner that is safe for the wildlife, the AV, and any passengers in the AV.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a block diagram illustrating a system including a fleet of AVs used for an autonomous driving service according to some embodiments of the present disclosure;

FIG. 2 is a block diagram of a sensor suite of an AV, according to some embodiments of the present disclosure;

FIG. 3 is a block diagram of external devices mounted on the AV, according to some embodiments of the present disclosure;

FIG. 4 is a block diagram illustrating selected systems of the onboard computer of the AV, according to some embodiments of the present disclosure;

FIG. 5 is an example user interface providing an update to a passenger about a detected animal, according to some embodiments of the present disclosure;

FIG. 6 is an example user interface requesting information from a passenger about a detected animal, according to some embodiments of the present disclosure;

FIG. 7 is a flowchart of an example method for classifying and responding to an animal near an AV, according to some embodiments of the present disclosure;

FIG. 8 is a flowchart of an example method for selecting a drop-off location near a detected animal, according to some embodiments of the present disclosure; and

FIG. 9 illustrates an example of a deep learning neural network that can be used to implement an animal identification system or an animal classification system, according to some aspects of the disclosed technology.

### DESCRIPTION OF EXAMPLE EMBODIMENTS OF THE DISCLOSURE

### Overview

The systems, methods and devices of this disclosure each have several innovative aspects, no single one of which is solely responsible for all of the desirable attributes disclosed herein. Details of one or more implementations of the subject matter described in this specification are set forth in the description below and the accompanying drawings.

When an AV encounters an animal in or near a roadway, there are a number of different actions that the AV could take to avoid a collision with the animal. For example, depending on other traffic, an AV may reverse away from the animal, or perform a U-turn to drive away from the animal. Alternatively, the AV may stop and wait for the animal to move, or slowly approach the animal, which may encourage the animal to move away from the roadway or to not enter the roadway. In some cases, if an animal is relatively far from a roadway and is relatively slow-moving, it may be preferable for the AV to drive at its normal speed along the roadway before the animal can reach the roadway. In some cases, the AV may have one or more output devices that can be used to repel animals away from the AV and off the roadway. For example, an audio device can make a sound to repel the animal, or the AV may turn on or flash its lights.

Different tactics may have more positive effects on different types of animals. For example, different animals are expected to respond differently to different types of stimuli, e.g., some nocturnal animals (e.g., raccoons) may retreat if exposed to light, while others (e.g., deer) may freeze in place if exposed to a light. As another example, different animals have different hearing ranges, and thus may respond differently to different audio frequencies based on what they are able to hear. Some animals may have a risk of charging a vehicle, or climbing on a vehicle and damaging equipment; when faced with such animals, it may be more appropriate for the AV to stop or try to retreat than for the AV to approach the animal or take actions that may draw an animal's attention to the AV.

Selecting an appropriate tactic for a particular animal can reduce the risk of collision with the animal or other adverse actions to the AV, passengers, and the animal. Furthermore, selecting tactics tailored to a specific animal can reduce environmental impacts of AVs on their surroundings. For example, if a short light flash is expected to deter a particular animal, this may create less disturbance to the animal and other wildlife in the environment than a longer or brighter light display or a combination of lights and sounds.

As described herein, an AV includes various sensors for collecting data describing the environment around the AV. Processing circuitry, such as an onboard computer of the AV, can process this data to detect any animals in the environment of the AV. If the processing circuitry detects an animal, a further classification process may be performed to identify the particular animal, e.g., to identify a species or other class of animal to which the detected animal belongs. In some embodiments, the identity of the animal may be determined based on the sensor data (e.g., images of the animal, radar data that may indicate the animal's movement and speed, audio recordings of the animal) as well as additional environmental data, such as the time of day, the current location of the AV, and previous animal sightings in the area (e.g., by other AVs).

After classifying the animal, the processing circuitry may determine a particular action or course of action to take. The action may be further based on additional information, such as the relative locations of the AV and the animal, the location of the animal relative to the roadway, or the presence of any fencing between the animal and the roadway. For example, if the processing circuitry detects a cow on a roadway, the AV may stop and wait for the cow to move; on the other hand, if the processing circuitry detects a cow in a grassy field next to the roadway, the AV may proceed along the roadway at a normal speed.

An AV may take care of particular animals at a pickup or drop-off point, to avoid creating a disturbance to animals by user activity and/or to avoid risk to passengers or other users that may be caused by the animals. For example, if the AV stops to drop off a passenger, the AV sensors may collect data from the immediate vicinity of the AV. If the AV detects an animal and classifies it as an animal that may be dangerous to the passenger (e.g., a rattlesnake), the AV may determine to continue driving to a different location before dropping off the passenger.

As used herein, an animal may be “near” or “proximate to” a planned pathway for an AV if, for example, the animal is within, or is estimated (based on sensor data) to be within, a threshold distance (e.g., 5 feet, 10 feet, 20 feet, 50 feet, etc.) of a roadway that the planned pathway is along, or a particular lane or other portion of the roadway that the planned pathway is along. In various embodiments, different thresholds may be used in different situations, e.g., a greater threshold distance may be used if the AV is traveling at a lower speed, or a greater threshold distance may be used for animals that tend to move more quickly (e.g., a deer is proximate to a roadway if it is within 100 feet of the roadway, while a turtle is proximate to a roadway if it is within 10 feet of the roadway). In some embodiments, any animal detected in the environment of the AV, or within a threshold distance from the AV (e.g., at least 50 feet or at least 100 feet from the AV), can be considered “near” or “proximate to” the planned pathway. In some embodiments, an animal that is generally in front of the AV, e.g., in a field of view directed outwards from the front of the AV and includes at least a portion of the planned pathway, is considered “near” or “proximate to” the planned pathway. Furthermore, an animal may be “near” or “proximate to” an AV itself if the animal is within, or is estimated to be within, a threshold distance (e.g., 5 feet, 10 feet, 20 feet, etc.) of the AV, or of one or more particular doors of the AV.

In some embodiments, a fleet of AVs is used to experimentally determine tactics for responding to particular animals. For example, different AVs may be programmed to perform different actions (e.g., slowly approach, stop, flash headlights, make sounds, etc.) in response to detecting a particular animal (e.g., a deer on the roadway). In some embodiments, each of the different actions may be selected to avoid a collision with the animal. The AVs in the fleet may collect data indicating the animal's response, e.g., how quickly the deer vacated the roadway, or a delay caused by the deer. A fleet management system may utilize the collected data to establish one or more protocols for responding to a particular animal or animals on or near a roadway. For example, the fleet management system may select the tactic that may minimize AV delay or minimized the amount of time for the deer to vacate the roadway.

As will be appreciated by one skilled in the art, aspects of the present disclosure, in particular aspects of classifying and responding to wildlife near an AV, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g., one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g., to the existing perception system devices and/or their controllers, etc.) or be stored upon manufacturing of these devices and systems.

The following detailed description presents various descriptions of specific embodiments. However, the innovations described herein can be embodied in a multitude of different ways, for example, as defined and covered by the claims and/or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

### Example AV System for Animal Detection, Classification, and Avoidance

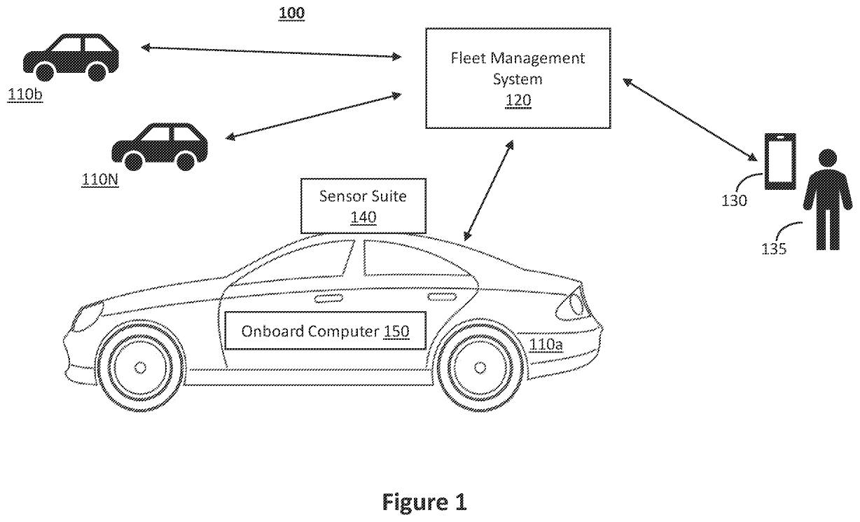

FIG. 1 is a block diagram illustrating a system including a fleet of AVs used for an autonomous driving service according to some embodiments of the present disclosure. The system 100 includes a fleet of AVs 110, including AV 110a, AV 110b, and AV 110N, a fleet management system 120, and a user device 130. For example, a fleet of AVs may include a number N of AVs, e.g., AV 110a through AV 110N. AV 110a includes a sensor suite 140 and an onboard computer 150. AVs 110b through 110N also include the sensor suite 140 and the onboard computer 150. A single AV in the fleet is referred to herein as AV 110, and the fleet of AVs is referred to collectively as AVs 110.

The fleet management system 120 receives service requests for the AVs from user devices, such as user device 130. For example, the user 135 accesses an app executing on the user device 130 and, using the app, enters a ride request. The user device 130 transmits the ride request to the fleet management system 120. The ride request includes at least a pickup location (e.g., the current location of the user device 130) and may further include a drop-off location, a number of passengers, a pickup and/or drop-off time, or other information. The fleet management system 120 selects an AV from the fleet (e.g., AV 110a) and dispatches the selected AV to the pickup location to carry out the ride request.

The AV 110 is preferably a fully autonomous automobile, but may additionally or alternatively be any semi-autonomous or fully autonomous vehicle; e.g., a boat, an unmanned aerial vehicle, a driverless car, etc. Additionally, or alternatively, the AV 110 may be a vehicle that switches between a semi-autonomous state and a fully autonomous state and thus, the AV may have attributes of both a semi-autonomous vehicle and a fully autonomous vehicle depending on the state of the vehicle.

The AV 110 may include a throttle interface that controls an engine throttle, motor speed (e.g., rotational speed of electric motor), or any other movement-enabling mechanism; a brake interface that controls brakes of the AV (or any other movement-retarding mechanism); and a steering interface that controls steering of the AV (e.g., by changing the angle of wheels of the AV). The AV 110 may additionally or alternatively include interfaces for control of any other vehicle functions, e.g., windshield wipers, headlights, turn indicators, air conditioning, etc. Additional external devices of the AV 110, including speakers and a spray system, are described in relation to FIG. 3.

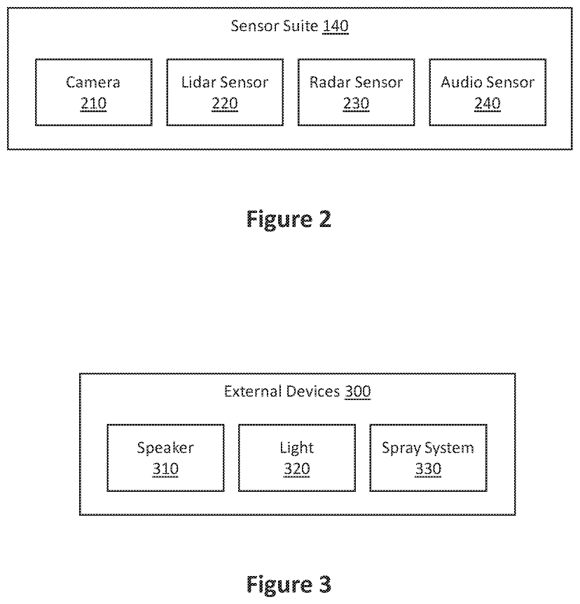

The AV 110 includes a sensor suite 140, which includes a computer vision (“CV”) system, localization sensors, and driving sensors. For example, the sensor suite 140 may include interior and exterior cameras, radar sensors, sonar sensors, lidar (light detection and ranging) sensors, thermal sensors, GPS, wheel speed sensors, inertial measurement units (IMUs), accelerometers, microphones, strain gauges, pressure monitors, barometers, thermometers, altimeters, ambient light sensors, etc. The sensors may be located in various positions in and around the AV 110. For example, the AV 110 may have multiple cameras located at different positions around the exterior and/or interior of the AV 110. Particular components of the sensor suite 140 are described in greater detail in relation to FIG. 2.

The onboard computer 150 is connected to the sensor suite 140 and functions to control the AV 110 and to process sensed data from the sensor suite 140 and/or other sensors to determine the state of the AV 110. Based upon the vehicle state and programmed instructions, the onboard computer 150 modifies or controls behavior of the AV 110. The onboard computer 150 may be a general-purpose computer adapted for I/O communication with vehicle control systems and sensor suite 140, but may additionally or alternatively be any suitable computing device. The onboard computer 150 is preferably connected to the Internet via a wireless connection (e.g., via a cellular data connection). Additionally or alternatively, the onboard computer 150 may be coupled to any number of wireless or wired communication systems.

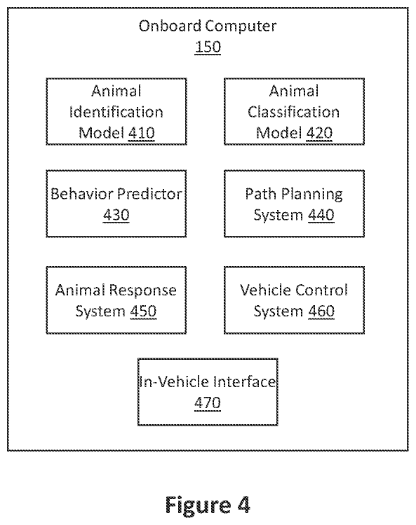

The onboard computer 150 may detect and classify animals in the environment of the AV 110 based, at least in part, on data from the sensor suite 140. For example, the onboard computer 150 may implement one or more machine-learned models for recognizing animals in the environment of the AV 110. The onboard computer 150 may access guidelines or instructions for responding to particular animals recognized in the environment of the AV, as described further below. The onboard computer 150 may generate and transmit instructions to the throttle interface, brake interface, steering interface, or other interfaces based on a determined tactic or strategy for responding to an animal. The onboard computer 150 is described further in relation to FIG. 4.

The fleet management system 120 manages the fleet of AVs 110. The fleet management system 120 may manage one or more services that provides or uses the AVs, e.g., a service for providing rides to users using the AVs. The fleet management system 120 also manages fleet maintenance tasks, such as fueling, inspecting, and servicing of the AVs. The fleet management system 120 may receive information about detected animals and/or a response of the AV 110 to the detected animals. The AVs 110 and the fleet management system 120 may connect over a public network, such as the Internet.

The user device 130 is a personal device of the user 135, e.g., a smartphone, tablet, computer, or other device for interfacing with a user of the fleet management system 120. The user device 130 and the fleet management system 120 may connect over a public network, such as the Internet. The user device 130 may provide one or more applications (e.g., mobile device apps or browser-based apps) with which the user 135 can interface with a service that provides or uses AVs, such as a service that provides rides to users in AVs, or a delivery service that delivers items to a location specified by a user. The service, and particularly the AVs associated with the service, is managed by the fleet management system 120, which may also provide the application to the user device 130.

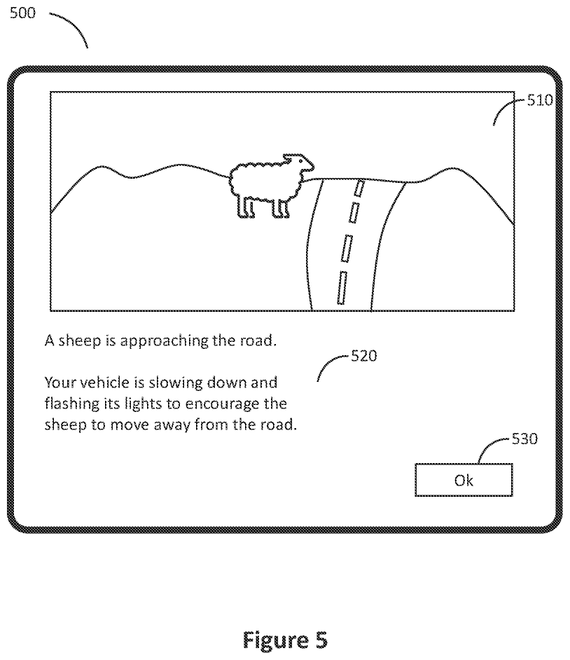

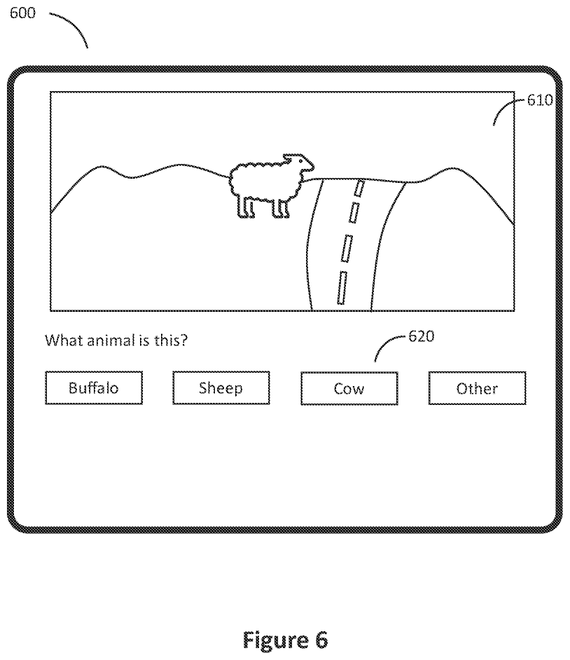

The application may provide a user interface to the user 135 during rides, such as a map showing the location of the AV 110 and the destination location. The user interface provided on the user device 130 and/or on a built-in interface of the AV 110 may also provide information about a detected animal to a user, provide information about decisions made by the AV 110 in response to a detected animal to a user, or request information from a user about a detected animal. Two example interfaces provided by the AV 110 are shown in FIGS. 5 and 6.

### Example AV Sensor Suite

FIG. 2 is a block diagram of the sensor suite 140 of the AV 110, according to some embodiments of the present disclosure. The sensor suite 140 includes a set of environmental sensors, e.g., a camera 210, a lidar sensor 220, a radar sensor 230, and an audio sensor 240. Different and/or additional components may be included in the sensor suite 140. For example, the sensor suite 140 may also include photodetectors, sonar, GPS, wheel speed sensors, IMUs, accelerometers, microphones, strain gauges, pressure monitors, barometers, thermometers, altimeters, etc., as described with respect to FIG. 1. Further, while one of each of the sensors 210, 220, 230, and 240 is shown in FIG. 2, the sensor suite 140 may include more than one of each of these components, e.g., to capture the environment around the AV 110 from different positions and angles, and for redundancy.

The sensor suite 140 includes multiple types of sensors, each of which has different attributes and advantages. Combining data from many multiple sensors and different sensor types allows the AV 110 to obtain a more complete view of its environment and allows the AV 110 to learn about its environment in different conditions, e.g., at different travel speeds, and in different lighting conditions.

The camera 210 captures images of the environment around the AV 110. The sensor suite 140 may include multiple cameras 210 to capture different views, e.g., a front-facing camera, a back-facing camera, and side-facing cameras. Cameras 210 may be mounted to capture a region near each door to the AV 110, which enables the AV 110 to detect any animals near doors during drop-off or pick up. The cameras 210 may be implemented using high-resolution imagers with fixed mounting and field of view. One or more cameras 210 may capture light at different frequency ranges. For example, the sensor suite 140 may include one or more infrared cameras and/or one or more ultraviolet cameras in addition to visible light cameras.

The lidar sensor 220 measures distances to objects in the vicinity of the AV 110 using reflected laser light. The lidar sensor 220 may be a scanning lidar that provides a point-cloud of the region scanned. The lidar sensor 220 may have a fixed field of view or a dynamically configurable field of view.

The radar sensor 230 measures ranges and speeds of objects in the vicinity of the AV 110 using reflected radio waves. The radar sensor 230 may be implemented using a scanning radar with a fixed field of view or a dynamically configurable field of view. As described with respect to the cameras 210, the sensor suite 140 may include multiple radar sensors 230 to capture different fields of view. Radar sensors 230 may include articulating radar sensors, long-range radar sensors, short-range radar sensors, or some combination thereof.

In some embodiments, other types of time-of-flight sensors, such as time-of-flight cameras, infrared depth sensors, 3D scanners, structured light scanners, or other types of ranging techniques are used in addition to or instead of lidar and/or radar.

The audio sensor 240 captures sound in the vicinity of the AV 110. The audio sensor 240 may be implemented using one or more microphones that convert sound signals to digital signals. The audio sensor 240 may be configured to capture sound across a variety of frequencies, including ultrasonic waves (e.g., sound waves with a frequency above 20 kHz) or infrasonic waves (e.g., sound waves with a frequency below 20 Hz).

The data collected by the camera 210, lidar sensor 220, radar sensor 230, and audio sensor 240 is used to detect one or more objects surrounding the AV 110. For example, the sensor suite 140 produces a data set that can be used by the onboard computer 150 to detect other cars, pedestrians, animals, trees, bicycles, and other objects within and/or near a road along which the AV 110 is traveling. The data set collected by these environmental sensors can be used to first detect animals or potential animals around the AV 110, and then to classify the detected animals, e.g., as a particular species of animal (e.g., white-tailed deer, eastern diamondback rattlesnake) or group of animals (e.g., deer, snake).

### Example AV External Devices for Deterring Animals

FIG. 3 is a block diagram of external devices 300 mounted on the AV 110 that may be used to deter animals, according to some embodiments of the present disclosure. The external devices 300 includes a speaker 310, a light 320, and a spray system 330. Different and/or additional components may be included in the sensor suite 140. Further, while one of each of the devices 310, 320, 330 is shown in FIG. 3, the external devices 300 may include more than one of each of these components, e.g., multiple lights with different colors and/or facing in different directions.

The speaker 310 is located on the AV 110 and emits sounds outside the AV 110, including sounds that may deter detected animals. The speaker 310 is able to emit sounds that are audible to certain animals outside of the AV 110. The speaker 310 may emit sounds at a particular frequency or range of frequencies. The range of frequencies may be larger than or different from a range associated with human hearing. For example, the speaker 310 may produce sounds in a high frequency range that can be detected by certain animals, but may not be audible to humans.

In some embodiments, the speaker 310 produces a fixed sound or set of sounds. For example, the speaker 310 may be a car horn or a low-speed noise emitter. In other embodiments, the speaker 310 may reproduce a larger range of sounds, e.g., words, jingles, beeps, sirens, etc., and may be instructed to play back a particular sound or recording. In some embodiments, the speaker 310 generates an audible vibration or a buzzing sound. In some embodiments, the speaker 310 generates specific animal calls expected to alert or scare away a specific animal or animals (e.g., a sound of a cougar may cause deer or other prey animals to flee). The external devices 300 may include multiple speakers 310, e.g., speakers 310 directed in different directions around the AV 110 (e.g., front-facing speakers, side-facing speakers, rear-facing speakers) and/or speakers 310 to produce different types of sounds or sounds at different frequencies.

In some embodiments, the speaker 310 is a directional speaker that can emit sound in a particular direction selected from a larger range of directions. For example, the onboard computer 150 may determine the direction of a detected animal relative to the speaker 310 and instruct the speaker 310 to emit sound in that direction.

The light 320 is located on the AV 110 and emits light outside the AV 110. If directed at or visible to a detected animal, the light may deter a detected animal or encourage the animal to leave a path of the AV 110. The AV 110 may have a number of lights 320 primarily intended for other purposes, such as a headlights, fog lights, high beams, running lights, brake lights, tail lights, license plate lights, and external displays; these lights may be used for animal deterrence, e.g., by turning on a light (e.g., a high-beam) when an animal is detected, or turning the light on and off according to a pattern (e.g., flashing the high-beams or headlights). In addition, one or more additional lights 320 specifically included for animal deterrence may be mounted on the AV 110, e.g., near a front of the AV 110, or near the doors of the AV 110.

A light 320 may emit light at a particular frequency, set of frequencies, or range of frequencies. A light 320 may be capable of emitting light at one or more frequencies outside of a normal range of human vision, e.g., the light 320 may emit infrared light or ultraviolet light.

In some embodiments, the AV 110 includes a spray system 330 that can spray a liquid outside of the AV 110, e.g., in the direction of an animal, to deter a detected animal. The spray system 330 may include a reservoir, one or more nozzles connected to the reservoir, and a control mechanism for drawing a liquid from the reservoir and through a nozzle. A pointing direction of a nozzle may be controllable, e.g., to aim the nozzle at the detected animal, where the onboard computer 150 determines that the animal is located in a particular direction relative to the nozzle. The reservoir may be a reservoir for a liquid that has an additional purpose on the AV 110, e.g., a reservoir of windshield wiper fluid, or a reservoir of water that may be used to cool a battery.

### Example Onboard Computer

FIG. 4 is a block diagram illustrating selected systems of the onboard computer 150 of the AV 110, according to some embodiments of the present disclosure. The onboard computer 150 includes an animal identification model 410, an animal classification model 420, a behavior predictor 430, a path planning system 440, an animal response system 450, a vehicle control system 460, and in-vehicle interface 470. In alternative configurations, fewer, different and/or additional components may be included in the onboard computer 150. Further, functionality attributed to one component of the onboard computer 150 may be accomplished by a different component included in the onboard computer 150 or a different system than those illustrated.

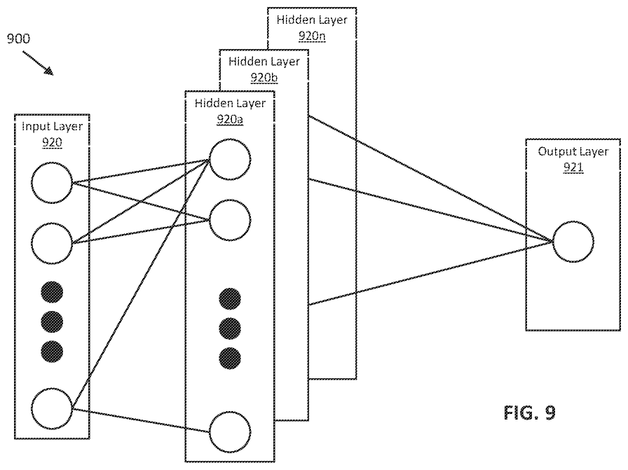

The animal identification model 410 identifies animals in the environment of the AV 110. The animal identification model 410 receives sensor data describing the environment surrounding the AV 110. The sensor data is collected by the sensor suite 140, described with respect to FIG. 2. The sensor data used by the animal identification model 410 may include data from a subset of sensors in the sensor suite 140, e.g., data from one or more cameras 210, or data from a camera 210 and the lidar sensor 220. The animal identification model 410 may be trained based on a training data set gathered by one or more AVs with similar sensor suites to the sensor suite 140. The training data may be labeled to indicate whether the training data includes animals, and the locations of the animals, and a machine-learned model may be trained from the training data to detect humans in sensor data gathered in real-time by the sensor suite 140. The animal identification model 410 may be implemented as a neural network, such as the neural network described with respect to FIG. 9; the inputs (e.g., the sensor data described above) may be provided as an input layer to the neural network. The animal identification model 410 may identify multiple animals in the environment of the AV 110 and determine a number of the identified animals and the respective locations of each of the identified animals.

In some embodiments, due to the great variety of animal morphologies, the animal identification model 410 may be trained to identify a particular set of animals. For example, the animal identification model 410 may identify large animals (e.g., larger than about 1 foot long, or larger than about 30 pounds). In some embodiments, the onboard computer 150 may include multiple animal identification models, e.g., one animal identification model for terrestrial mammals, another animal identification model for reptiles, and another animal identification model for insects. In some embodiments, an animal identification model 410 may be trained to detect animals typical of a region (e.g., desert-dwelling animals for AVs operating in a desert). In some embodiments, an animal identification model 410 may be trained to detect animals that are known to have adverse interactions with AVs 110 (e.g., deer), and may not be specifically trained to detect animals that are not expected to have adverse interactions with AVs 110 (e.g., squirrels).

The onboard computer 150 may include one or more animal classification models 420 to determine a classification for the detected animal or animals. In some embodiments, the animal classification model 420 is a binary classification model trained to determine whether a detected animal is a particular type of animal (e.g., a particular species, or a group of morphologically similar species). In such embodiments, the onboard computer 150 may store multiple animal classification models 420, e.g., different models for different types of animals. In other embodiments, the animal classification model 420 is a multiclass classification model trained to determine which of a set of animals the detected animal belongs to. For example, the animal classification model 420 may output a vector of probabilities each corresponding to a respective probability that a detected animal belongs to a particular class of animal (e.g., a probability that a detected animal is a deer, a probability that a detected animal is a snake, etc.).

The animal classification model 420 may receive various inputs and classify the detected animal based on the inputs. For example, the animal classification model 420 may be implemented as a neural network, such as the neural network described with respect to FIG. 9; the inputs may be provided as an input layer to the neural network. The inputs may include sensor data, e.g., data, or a portion of the data, collected by one or more sensors of the sensor suite 140. For example, if the animal identification model 410 detects an animal at a particular location or position relative to the AV 110, the onboard computer 150 may provide one or more images captured by a camera 210 with a field of view that includes the particular location or position as an input to the animal classification model 420. In other examples, the onboard computer 150 may select a portion of a point cloud from the lidar sensor 220 and/or a portion of a point cloud from the radar sensor 230 as an input or inputs to the animal classification model 420. In some embodiments, the onboard computer 150 selects a portion of audio captured by a microphone 240 as an input to the animal classification model 420, e.g., a clip of audio which may contain an animal call.

In addition to the sensor data, other data describing an environment of the AV 110 may be provided to the animal classification model 420. For example, the current location of the AV 110 (e.g., as a latitude and longitude), an elevation of the AV 110, or other data related to the current location of the AV 110 (e.g., a state or other geographic region, a Köppen climate classification or other type of climate classification) may be provided as an input or inputs to the animal classification model 420. As another example, the current time of day, time of year, current temperature, current weather conditions (e.g., raining, snowing, sunny, etc.) may be provided as inputs to the animal classification model 420. Each of these factors may be associated with certain animals, e.g., diurnal animals vs. nocturnal animals, times associated with breeding or other high levels of activity, animals that are more active in certain types of weather, etc. As still another example, information about other animals detected in the area (e.g., by other AVs 110 in the AV fleet) may be provided as inputs to the animal classification model 420.

In some embodiments, the output of the animal classification model 420 is compared to a list of animals expected to be in the environment of the AV 110, e.g., a list of animals native to the area, or a list of animals previously observed in the area. If, for example, the most likely animal classification output by the animal classification model 420 is not on a list of animals native to or otherwise expected in the location of the AV 110, the onboard computer 150 (e.g., the animal response system 450, described below) may select the second-most likely animal classification. For example, if the animal classification model 420 indicates that a particular animal has a 60% likelihood of being an elk, and a 40% likelihood of being a deer, but elk are not on a list of animals observed in the location of the AV 110, the animal response system 450 may determine that the animal is a deer.

In some embodiments, the animal classification model 420 may classify a particular animal as an adult or a juvenile. In some cases, the animal classification model 420 may approximate an age for an animal, or classify an animal in an age bucket (e.g., baby, youth, adult). If an animal is sexually dimorphic, the male and female animals may have different classifications.

In some embodiments, rather than including one or more animal identification models 410 and one or more animal classification models 420, the onboard computer 150 may include many different animal identification models 410 targeted to specific animals and omit the animal classification model(s) 420. Alternatively, the onboard computer 150 may omit the animal identification model(s) 410 and include one or more animal classification models 420. Still other architectures for identifying and/or classifying an animal in the environment of the AV 110 may be used. For example, multiple layers of animal classification models 420 may be used, e.g., a first animal classification model 420 may classify an animal as a snake, and a second animal classification model 420 may classify the snake as a venomous or non-venomous snake, or as a particular species of snake.

In some cases, the identification and/or classification of animals may tend to improve or become more specific as the AV 110 approaches the animals. For example, if an animal is detected a relatively long distance from the AV 110 (e.g., more than 500 feet or 1000 feet), the animal identification model 410 may detect an animal or possible animal, but the data from the sensor suite 140 may be only be sufficient to determine, for example, a speed of the animal and/or a rough size of the animal. The animal classification model 420 may not classify the animal with a high probability. As the AV 110 drives closer to the animal, the animal classification model 420 may be able to more accurately predict a species or other class of the animal. Thus, the onboard computer 150 may repeat the animal identification and/or classification steps as the AV 110 collects additional data. Furthermore, the animal response system 450 may choose different actions (e.g., actions directed to a specific animal, as opposed to a generic large animal) over time, as the classification improves.

The behavior predictor 430 predicts future behavior for a detected animal based on the determined classification and other data about the animal, e.g., the animal's location and current speed. For example, the behavior predictor 430 may predict an expected pathway or possible pathways that the animal may move along. The predicted pathway may be informed by the prior movement of the animal (e.g., speed and direction of travel) and the direction in which the animal is facing. If multiple pathways are predicted, the behavior predictor 430 may determine a statistical likelihood for each predicted pathway. The behavior predictor 430 may determine a predicted velocity or velocity profile for the predicted pathway, e.g., the behavior predictor 430 may predict that an animal (e.g., a deer) can run at velocities up to 40 miles per hour. As another example, the behavior predictor 430 may predict, based on a deer's current location, that the deer may enter the roadway in no less than 5 seconds. In some embodiments, the behavior predictor 430 or another component may determine a health or mobility status of the animal, e.g., whether the animal appears to be alive (and/or mobile) or dead or injured (and/or immobile).

The behavior predictor 430 may predict the behavior of the animal based on physical features of the animal's environment. For example, if the animal is not on the roadway, and the onboard computer 150 (e.g., a computer vision system) detects a fence between the animal and the roadway, the behavior predictor 430 may determine whether the animal can and/or is likely to cross the fence to enter the roadway. For example, if the fence is metal guardrail that is 3 feet high, the animal classification model 420 classifies an animal as a deer, and the behavior predictor 430 determines that the deer is running towards the road, the behavior predictor 430 may further determine that the deer can jump over the metal guardrail and onto the road. On the other hand, if the animal classification model 420 detects a pig next to the roadway, the behavior predictor 430 may determine that the pig cannot jump over or otherwise cross the metal guardrail and the pig is unlikely to enter the road.

In some embodiments, the behavior predictor 430 considers behaviors of groups of animals. For example, if the animal identifying model 410 identifies multiple animals, and the animal classification model 420 classifies the animals as an adult and babies of the same type of animal, the behavior predictor 430 may identify this as a family group and predict that the group may be traveling together.

The behavior predictor 430 may update the predicted behavior of the animal based on additional data (e.g., as the AV 110 drives closer to the animal) and based on progress of the animal or changes in its behavior (e.g., based on an animal's reaction to a deterrence action).

The path planning system 440 plans a path for the AV 110 based on data received from the sensor suite 140. The path planning system 440 may receive navigation information, e.g., a description of a planned route, or the address of a destination, and use this information to plan the path. The path planning system 440 further incorporates data describing real-time environmental data perceived by the sensor suite 140, including the location of other vehicles, traffic control signals and signs, pedestrians, bicycles, animals, etc., to plan the path. The path planning system 440 determines a planned pathway for the AV 110 to follow by applying path planning rules or models to the environmental data. When objects are present in the environment of the AV 110, the path planning system 440 determines the planned pathway for the AV 110 based on predicted pathways of the objects and right-of-way rules that regulate behavior of vehicles, bicycles, pedestrians, or other objects. If an animal is in or near the roadway, the path planning system 440 may determine a pathway that accounts for the location and/or predicted behavior of the animal, e.g., a path that avoids an animal, or slows down when approaching an animal. The path planning system 440 may receive a selected response from the animal response system 450 and plan the path based on the selected response.

The animal response system 450 receives data indicating that an animal is in the vicinity of the AV 110 (e.g., from the animal classification model 420) and selects one or more actions for the AV 110 to perform in response to the animal, e.g., to deter the animal from entering the roadway, or cause the animal to move out of the planned pathway of the AV 110. The action may generally be selected to better enable the AV 110 to traverse the planned path. The animal response system 450 may select the action based on additional data, such as the current location of the animal, the presence of other vehicles near the AV 110 and/or near the animal, the current speed of the AV 110, the type of AV 110 (e.g., a relatively large AV 110 may be less likely to be damaged by hitting an animal than a smaller AV 110), or other factors.

The animal response system 450 may determine one or more actions for the AV 110 before a classification can be determined, e.g., if the AV 110 is relatively far from the animal, and none of the possible classifications from the animal classification model 420 have at least a threshold probability (e.g., at least 50%, or at least 70%). In such cases, the animal response system 450 may select a generic response based on available data (e.g., a general size of the animal, and whether or not the animal is in the roadway). For example, if the animal is in the roadway, the animal response system 450 may determine that the AV 110 slows down until the animal can be classified. If the animal is relatively far from the roadway, the animal response system 450 may determine that the AV 110 does not slow down, but the sensor suite 140 and onboard computer 150 continually monitor the animal to determine if it approaches the roadway and/or poses a threat to the AV 110.

The animal response system 450 may be programmed with a set of rules or guidelines for different classifications of animals. For example, if the animal classification model 420 determines that a cow (which is unlikely to charge the AV 110) is in the planned pathway, the animal response system 450 may determine that the AV 110 slows down when approaching the cow and waits for the cow to move away from the roadway. The animal response system 450 may select an additional deterrence action, e.g., flashing the headlights, if the cow does not walk off the road. In some embodiments, the animal response system 450 may have a response escalation plan for a particular animal or set of animals. For example, the animal response system 450 may determine to first flash the headlights at the cow, and if this does not cause the cow to move, may determine to output a sound at the cow and/or spray water at the cow.

As another example, if the animal classification model 420 determines that a bison (which may charge the AV 110) is in the planned pathway, the animal response system 450 may determine that, if it is safe to (e.g., considering other traffic near the AV 110), the AV 110 retreat away from the bison, e.g., by making a U-turn or driving in reverse away from the bison until the bison is at least a threshold distance (e.g., 20 feet) away from the road.

As another example, if the animal classification model 420 and/or behavior predictor 430 identify a baby animal or a family group that includes one or more young, the animal response system 450 may cause the AV 110 to take particular care, e.g., to wait for extra time, or proceed more slowly. Causing the AV 110 to stop and proceed cautiously around babies can ensure that a family group can travel together, e.g., by allowing all babies in a litter to cross the road without the AV 110 separating the family. Stopping or driving more slowly can also help ensure that the sensor suite 140 and animal identification model 410 can detect any babies in the area, because babies may be more difficult to detect than a larger adult.

The animal response system 450 may provide multiple options to the path planning system 440 for responding to an animal, and the path planning system 440 may select the most suitable for the situation. For example, the animal response system 450 may indicate that turning around away from bison and re-routing is a first option, maintaining at least a threshold distance (e.g., at least 100 feet) away from the bison until the bison is off the road is a second option, and spraying the bison with water to hold back the bison is a third option. The path planning system 440 can select one of the options based on various factors, e.g., the practicality of re-routing (e.g., the possibility of making a U-turn, the amount of distance or time added to the route by re-routing), the practicality of keeping the threshold distance (e.g., if other cars are traveling in front of and/or behind the AV 110), the amount of water in the reservoir, or other factors.

In some embodiments, the animal response system 450 selects an action for the AV 110 to perform if an animal is detected at a location selected for a user to interact with the AV 110, e.g., a location for the AV 110 to stop for a delivery user to access the AV 110 (e.g., to load a delivery item into the AV 110, or to pick up a delivery item from the AV 110), or a location for a rider to enter or exit the AV 110. If an animal is detected near the AV 110, e.g., near a door of the AV 110 that a user is expected to open, the animal response system 450 may determine, based on the type of animal, whether the AV 110 should move to a different location, away from the animal. If, for example, the animal classification model 420 determines that a detected animal near the door of the AV 110 is a squirrel, the animal response system 450 may determine not to move, as the squirrel is likely to move away from the AV 110 and does not pose a threat to the user. Alternatively, if the animal classification model 420 determines that a detected animal near the door of the AV 110 is a rattlesnake, the animal response system 450 may determine to move to a different location, as the rattlesnake may pose a threat to the user.

In some embodiments, or for certain animals, the animal response system 450 may determine to stay in the selected location for user interaction and select an action intended to move the animal away from the AV 110, e.g., using any of the external devices 300. In some embodiments, the animal response system 450 may also consider whether the user or AV 110 may be a threat to the animal, e.g., if the selected location is near an animal's nest, or near an injured animal, in which case the animal response system 450 determines to move to a different location to protect the animal.

In some embodiments, users may provide information about sensitivities to certain animals that the animal response system 450 may consider when determining whether to move to a different location for user interaction. For example, a user may indicate (e.g., through an app) that they are afraid of dogs or allergic to bees. If the animal response system 450 determines that a bee is near the AV 110 at a selected location for a user interaction, the animal response system 450 may normally not determine to move to a different location for a user interaction (as bees do not generally pose a threat), but if the user is allergic to bees, the animal response system 450 may determine to move to a different location for interaction with that particular user.

After initiating a response, the animal response system 450 may obtain additional sensor data (e.g., from the sensor suite 140) or other data describing the animal, e.g., an updated location of the animal. The updated location may be provided by the animal identification model 410 or other computer vision algorithms implemented by the onboard computer 150. The additional data may include additional information, such as a current speed of the animal, or a revised planned behavior of the animal (e.g., from the behavior predictor 430). The animal response system 450 may determine a course of action based on the updated location and/or other information. For example, if the animal response system 450 determines that the animal is leaving the roadway or has left the roadway, the animal response system 450 may determine that the AV 110 can traverse the roadway along the planned path. As another example, if the animal response system 450 determines that the animal has left the area around the AV door, or a new drop-off location does not have an animal near the door, the animal response system 450 may determine that the AV 110 can unlock the doors and instruct the user to exit the AV 110.

The animal response system 450 may transmit information to the fleet management system 120 describing an animal in the environment of the AV 110. The animal response system 450 may provide, to the fleet management system 120, a location or approximate location for the animal (e.g., the current location of the AV 110, or an estimated location of the animal), information describing the animal (e.g., classification of the animal, speed, direction of travel, other behavioral features, a number of similar animals), a time at which the AV 110 observed the animal, a response taken by the AV 110, or other information relating to the animal observation. The fleet management system 120 may use this information to alter routing and/or driving behaviors of other AVs in the AV fleet. For example, if the animal may be aggressive or otherwise disruptive, the fleet management system 120 may instruct one or more other AVs 110 to route around the location where the animal was observed. As another example, the fleet management system 120 may instruct other AVs 110 in the area to drive more slowly or cautiously. The fleet management system 120 may aggregate animal observations by AVs 110 in the fleet to improve the animal classification model 420. For example, as described above, the animal classification model 420 may use a list of previously observed animals in an area to classify a newly observed animal.

In some embodiments, the rules or guidelines implemented by the animal response system 450 may be learned experimentally by a fleet of AVs 110. For example, different AVs may be programmed to perform different actions (e.g., slowly approach, stop, turn around, flash headlights or other AV lights, make different types of sounds or sounds at different frequencies, spray liquid at the animal, etc.) in response to detecting a particular animal (e.g., a deer on the roadway). Each of the actions may be selected to avoid, or try to avoid, a collision with the animal (e.g., maintaining current speed towards a large animal in the planned path may not be one of the experimental options). Each AV 110 may collect data indicating the animal's response and/or success of the action and transmit the data to the fleet management system 120. For example, each AV 110 may determine how quickly the animal vacated the roadway, or a duration of delay caused by the animal, and transmit this information to the fleet management system 120. AVs 110 may also collect any data describing adverse responses of the animal or adverse impacts on the AV 110, e.g., any contact between the AV 110 and the animal, or detected impacts on the animal (e.g., if an animal was startled by the AV action and ran into the path of another vehicle). In some embodiments, a user interface may collect data describing users' satisfaction with responses to animals performed by the AVs, e.g., by seeking feedback from users when an animal is detected.

The fleet management system 120 may utilize the collected data to establish one or more protocols for responding to a particular animal or animals on or near a roadway. For example, the fleet management system 120 may select the action or group of actions that minimized AV delay caused by the particular animal or minimized the amount of time for the animal to vacate the roadway. The fleet management system 120 may also weigh data describing user satisfaction and/or adverse impacts on the animal when determining a protocol. The fleet management system 120 may provide these guidelines to the animal response system 450.

In some embodiments, the fleet management system 120 may select guidelines based on additional factors, e.g., expected disturbance to the animal and/or other animals caused by the actions. For example, for a given animal, if a high-frequency sound and flashing lights resulted in a 10 second average delay and no collisions, while flashing lights only resulted in a 11 second delay and no collisions, the fleet management system 120 may select flashing lights as a preferred action when that animal is encountered on the roadway, as using lights only is expected to cause less of a disturbance to wildlife.

The vehicle control system 460 instructs the movement-related subsystems of the AV 110 to maneuver according to the planned pathway provided by the path planning system 440. As noted above, the path selected by the path planning system 440 may be altered based on information from the animal response system 450. The vehicle control system 460 may include the throttle interface for controlling the engine throttle, motor speed (e.g., rotational speed of electric motor), or any other movement-enabling mechanism; the brake interface for controlling the brakes of the AV 110 (or any other movement-retarding mechanism); and the steering interface for controlling steering of the AV 110 (e.g., by changing the angle of wheels of the AV). In some embodiments, the vehicle control system 460 further includes one or more interfaces for controlling the external devices 300 based on one or more actions selected by the animal response system 450.

The in-vehicle interface 470 provides information and/or options for the user during the ride via the in-vehicle display. While the in-vehicle interface 470 is illustrated as being part of the onboard computer 150, in other embodiments, the in-vehicle interface 470 is provided by a separate computer, which may be in communication with the onboard computer 150. Example display screens provided by the in-vehicle interface 470 are shown in FIGS. 5 and 6. In some embodiments, the in-vehicle interface 470 is interactive, e.g., via a touch screen or other user input device. In some embodiments, the in-vehicle interface 470, or a separate interface, are provided by the user device 130. If the AV 110 encounters an animal while a passenger is in the AV 110, the in-vehicle interface 470 can provide updates to the passenger about the animal and/or the AV's response to the animal. Furthermore, in some embodiments, the in-vehicle interface 470 may request information from a user, e.g., an identification of an animal or a description of the animal's behavior, which the fleet management system 120 may use to train the animal identification model 410, animal classification model 420, or animal response system 450. In some embodiments, the in-vehicle interface may enable a user to input a request for the AV 110 to perform a particular action in response to the animal, e.g., turn around or flash the headlights.

### Example User Interfaces

FIG. 5 is an example user interface 500 providing an update to a passenger about a detected animal, according to some embodiments of the present disclosure. The user interface 500 includes an image 510 of the animal (in this case, a sheep) in the environment of the AV 110. The image 510 may be an image from a specific camera 210 pointing in the direction of the identified animal. The image 510 may be a video that updates in real-time based on images captured by the camera 210. The user interface 500 further includes a textual description 520 of the actions taken by the AV 110, e.g., as determined by the animal response system 450. The user interface further includes an OK button 530 that the user may select to return to a previous screen, e.g., a map view.

FIG. 6 is an example user interface 600 requesting information from a passenger about a detected animal, according to some embodiments of the present disclosure. In this example, the user interface 600 includes an image 610 of the animal (in this case, a sheep) in the environment of the AV 110. The image 610 is similar to the image 510. In this example, the user interface 600 further includes a question posed to the user to identify the animal. The user can select one of the buttons 620 to indicate which animal is in the road. The fleet of AVs 110 may collect this data and transmit it to the fleet management system 120, which can use the collected data to train or tune the models for animal identification and/or animal classification.

### Example Processes for Detecting and Responding to Animals Near AVs

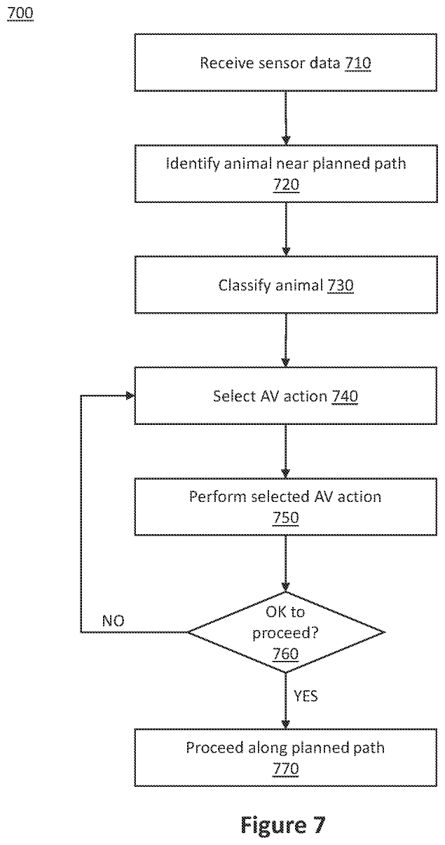

FIG. 7 is a flowchart of an example process 700 for classifying and responding to an animal near an AV, according to some embodiments of the present disclosure. An AV 110 (e.g., an onboard computer 150) receives 710 sensor data from sensors of the AV 110, e.g., the sensors 210-240 of the sensor suite 140 described with respect to FIG. 2. The AV 110 (e.g., the animal identification model 410) identifies 720 an animal near the planned path of the AV 110 based on the sensor data, as described with respect to FIG. 4. For example, the path planning system 440 may plan a path that traverses a roadway, and the animal identification model 410 identifies an animal that is on the roadway or next to the roadway (e.g., within 20 feet or 50 feet of the roadway). The AV 110 (e.g., the animal classification model 420) further classifies 730 the identified animal, as described with respect to FIG. 4. The classification may be based on the sensor data and/or additional data describing the environment of the AV 110 (e.g., the date, the time, and the location of the AV 110).

The AV 110 (e.g., the animal response system 450) selects 740 an AV action. The AV action may be or include a driving action (e.g., slow down, stop, or turn around). The AV action may be or include a deterrence action (e.g., turn on or flash headlights, play a sound audible to the animal, spray water at the animal). The AV 110 performs 750 the selected action. For example, the vehicle control system 460 interfaces with the relevant subsystem or subsystems to implement the selected action or actions.

The AV 110 (e.g., the animal response system 450) determines 760 whether it is OK for the AV 110 to proceed, e.g., if the animal is leaving or has left the roadway. If the animal response system 450 determines that it is not OK to proceed (e.g., an animal is still in the roadway), the animal response system 450 may return to 740 and select a further AV action. If the animal response system 450 determines that is it OK for the AV 110 to proceed, the AV 110 proceeds 770 along the planned pathway.

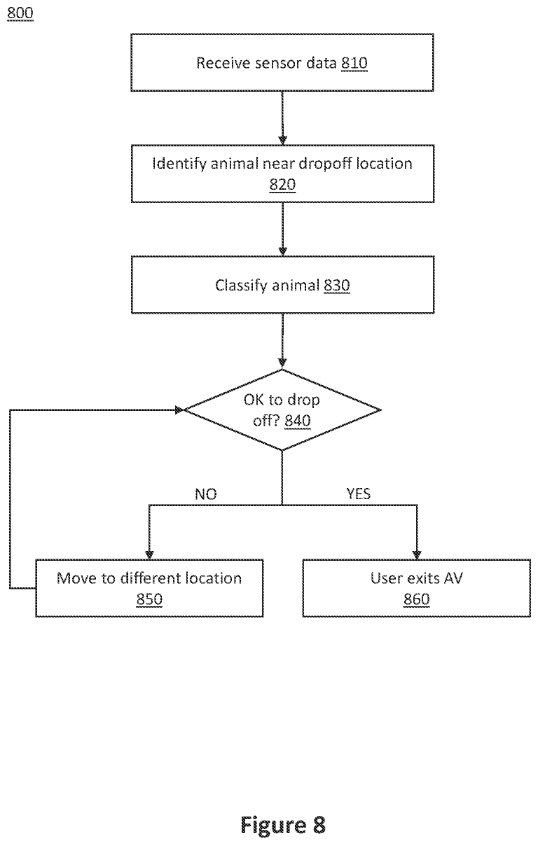

FIG. 8 is a flowchart of an example process 800 for selecting a drop-off location near a detected animal, according to some embodiments of the present disclosure. An AV 110 (e.g., an onboard computer 150) receives 810 sensor data from sensors of the AV 110, e.g., the sensors 210-240 of the sensor suite 140 described with respect to FIG. 2. The AV 110 (e.g., the animal identification model 410) identifies 820 an animal near a planned drop-off location for the AV 110 based on the sensor data, as described with respect to FIG. 4. For example, the path planning system 440 may select a drop-off location for dropping off a passenger, and the animal identification model 410 identifies an animal that is near the drop-off location (e.g., within 5 feet or 10 feet of the AV door). The AV 110 (e.g., the animal classification model 420) further classifies 830 the identified animal, as described with respect to FIG. 4. The classification may be based on the sensor data and/or additional data describing the environment of the AV 110 (e.g., the date, the time, and the location of the AV 110).

The AV 110 (e.g., the animal response system 450) determines 840 whether it is OK for the AV 110 to proceed with the drop off, e.g., if the animal is or is not a threat to the user, or if the user is or is not a threat to the animal. If it is not OK for the AV 110 to proceed with the drop off, the AV 110 may move 850 to a different drop-off location, e.g., at least a threshold distance away (e.g., 20 feet) from the animal. Alternatively, as described with respect to FIG. 4, the AV 110 (e.g., the animal response system 450) may select one or more deterrence actions (e.g., outputting a sound that the animal may respond to) and determine if, whether the action has been taken, it is OK to drop off the user at that location (e.g., if the animal has moved away from the AV 110). If it is OK for the AV 110 to proceed with the drop off, the user may exit 860 the AV 110. For example, the vehicle control system 460 may unlock the AV doors, and the in-vehicle interface 470 may instruct the user to collect any items and leave the AV 110.

While FIG. 8 was described with respect to a drop-off location, a similar process may be performed for selecting a pick-up location or other location for user interaction near a detected animal.

### Example Neural Network Model

In FIG. 9, the disclosure now turns to a further discussion of models that can be used through the environments and techniques described herein. Specifically, FIG. 9 is an illustrative example of a deep learning neural network 900 that can be used to implement all or a portion of an animal identification system (e.g., the animal identification model 410) as discussed above, or all of a portion of an animal classification system (e.g., the animal classification model 420) as discussed above. An input layer 920 can be configured to receive sensor data (e.g., images from a camera 210, one or more point clouds from the lidar sensor 220 and/or radar sensor 230, and/or an audio signal captured by the audio sensor 240) and/or data relating to an environment surrounding an AV, such as the environment data mentioned above. The neural network 900 includes multiple hidden layers 922a, 922b, through 922n. The hidden layers 922a, 922b, through 922n include “n” number of hidden layers, where “n” is an integer greater than or equal to one. The number of hidden layers can be made to include as many layers as needed for the given application. The neural network 900 further includes an output layer 921 that provides an output resulting from the processing performed by the hidden layers 922a, 922b, through 922n. The output may include, for example, a probability that a particular type of object or animal is detected and/or data describing a location where an animal is detected.

The neural network 900 is a multi-layer neural network of interconnected nodes. Each node can represent a piece of information. Information associated with the nodes is shared among the different layers and each layer retains information as information is processed. In some cases, the neural network 900 can include a feed-forward network, in which case there are no feedback connections where outputs of the network are fed back into itself. In some cases, the neural network 900 can include a recurrent neural network, which can have loops that allow information to be carried across nodes while reading in input.

Information can be exchanged between nodes through node-to-node interconnections between the various layers. Nodes of the input layer 920 can activate a set of nodes in the first hidden layer 922a. For example, as shown, each of the input nodes of the input layer 920 is connected to each of the nodes of the first hidden layer 922a. The nodes of the first hidden layer 922a can transform the information of each input node by applying activation functions to the input node information. The information derived from the transformation can then be passed to and can activate the nodes of the next hidden layer 922b, which can perform their own designated functions. Example functions include convolutional, up-sampling, data transformation, and/or any other suitable functions. The output of the hidden layer 922b can then activate nodes of the next hidden layer, and so on. The output of the last hidden layer 922n can activate one or more nodes of the output layer 921, at which an output is provided. In some cases, while nodes in the neural network 900 are shown as having multiple output lines, a node can have a single output and all lines shown as being output from a node represent the same output value.

In some cases, each node or interconnection between nodes can have a weight that is a set of parameters derived from the training of the neural network 900. Once the neural network 900 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 900 to be adaptive to inputs and able to learn as more and more data is processed.

The neural network 900 is pre-trained to process the features from the data in the input layer 920 using the different hidden layers 922a, 922b, through 922n in order to provide the output through the output layer 921.

In some cases, the neural network 900 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 900 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½((target−output)²). The loss can be set to be equal to the value of E_total.

The loss (or error) will be high for the initial training data since the actual values will be much different than the predicted output. The goal of training is to minimize the amount of loss so that the predicted output is the same as the training output. The neural network 900 can perform a backward pass by determining which inputs (weights) most contributed to the loss of the network, and can adjust the weights so that the loss decreases and is eventually minimized.

The neural network 900 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 900 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

### Select Examples

Example 1 provides a method that includes identifying an animal in an environment of a vehicle based on sensor data obtained by one or more sensors mounted to an exterior of the vehicle, the animal proximate to a planned path for the vehicle; classifying the animal based on the sensor data and additional data describing the environment of the vehicle; selecting an action for the vehicle to perform based on the classification of the animal, the action selected to enable the vehicle to traverse the planned path; performing the selected action by the vehicle; obtaining additional sensor data, the sensor data including data describing the classified animal; and determining, based on the additional sensor data, that the vehicle can traverse the planned path.

Example 2 provides the method of example 1, where the additional data describing the environment of the vehicle includes at least one of a current time of day and a location of the vehicle.

Example 3 provides the method of example 2, further including retrieving a list of potential animals in the environment of the vehicle based on the additional data; and classifying the animal based on the list of potential animals.

Example 4 provides the method of example 1, where classifying the animal based on the sensor data and the additional data describing the environment of the vehicle includes inputting at least a portion of the sensor data and at least a portion of the additional data to a machine-trained classification model; and receiving data indicating a type of the animal from the machine-trained classification model.

Example 5 provides the method of example 1, where the action is selected from a set of vehicle actions including moving the vehicle towards the animal, moving the vehicle away from the animal, and moving the vehicle in a path around the animal.

Example 6 provides the method of example 1, where the action includes making a sound at a specific frequency, the specific frequency selected based on the classification of the animal.

Example 7 provides the method of example 1, further including transmitting data describing the animal and a location of the AV or the animal to a fleet management system, where the fleet management system instructs a second vehicle in a fleet to select a route that avoids the animal.

Example 8 provides a vehicle that includes a sensor suite including a plurality of sensors mounted to an exterior of the vehicle and to obtain sensor data describing an environment of the vehicle; and processing circuitry to identify an animal in an environment of the vehicle based on the sensor data, the animal proximate to a planned path for the vehicle; classify the animal based on the sensor data and additional data describing the environment of the vehicle; select an action for the vehicle to perform based on the classification of the animal, the action selected to enable the vehicle to traverse the planned path; instruct the vehicle to perform the selected action; receive additional sensor data from the sensor suite, the sensor data including data describing the classified animal; and determine, based on the additional sensor data, that the vehicle can traverse the planned path.

Example 9 provides the vehicle of example 8, where the additional data describing the environment of the vehicle includes at least one of a current time of day and a location of the vehicle.

Example 10 provides the vehicle of example 9, the processing circuitry further to retrieve a list of potential animals in the environment of the vehicle based on the additional data; and classify the animal based on the list of potential animals.

Example 11 provides the vehicle of example 8, where classifying the animal based on the sensor data and the additional data describing the environment of the vehicle includes inputting at least a portion of the sensor data and at least a portion of the additional data to a machine-trained classification model; and receiving data indicating a type of the animal from the machine-trained classification model.

Example 12 provides the vehicle of example 8, where the action is selected from a set of vehicle actions including moving the vehicle towards the animal, moving the vehicle away from the animal, and moving the vehicle in a path around the animal.

Example 13 provides the vehicle of example 8 further including an audio device, where the action includes outputting a sound from the audio device at a specific frequency, the specific frequency selected based on the classification of the animal.

Example 14 provides the vehicle of example 8, the processing circuitry further to transmit data describing the animal and a location of the AV or the animal to a fleet management system, where the fleet management system instructs a second vehicle in a fleet to select a route that avoids the animal.

Example 15 provides a non-transitory computer-readable medium storing instructions that, when executed by a processor, cause the processor to identify an animal in an environment of a vehicle based on sensor data obtained by one or more sensors mounted to an exterior of the vehicle, the animal proximate to a planned path for the vehicle; classify the animal based on the sensor data and additional data describing the environment of the vehicle; select an action for the vehicle to perform based on the classification of the animal, the action selected to enable the vehicle to traverse the planned path; perform the selected action by the vehicle; obtain additional sensor data, the sensor data including data describing the classified animal; and determine, based on the additional sensor data, that the vehicle can traverse the planned path.

Example 16 provides the non-transitory computer-readable medium of example 15, where the additional data describing the environment of the vehicle includes at least one of a current time of day and a location of the vehicle.

Example 17 provides the non-transitory computer-readable medium of example 16, where the instructions further cause the processor to retrieve a list of potential animals in the environment of the vehicle based on the additional data; and classify the animal based on the list of potential animals.

Example 18 provides the non-transitory computer-readable medium of example 15, where classifying the animal based on the sensor data and the additional data describing the environment of the vehicle includes inputting at least a portion of the sensor data and at least a portion of the additional data to a machine-trained classification model; and receiving data indicating a type of the animal from the machine-trained classification model.

Example 19 provides the non-transitory computer-readable medium of example 15, where the action is selected from a set of vehicle actions including moving the vehicle towards the animal, moving the vehicle away from the animal, and moving the vehicle in a path around the animal.

Example 20 provides the non-transitory computer-readable medium of example 15, where the instructions further cause the processor to transmit data describing the animal and a location of the AV or the animal to a fleet management system, where the fleet management system instructs a second vehicle in a fleet to select a route that avoids the animal.

### Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the FIGS. may be combined in various possible configurations, all of which are clearly within the broad scope of this Specification.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

What is claimed is:

1. A method comprising:
identifying an animal in an environment of a vehicle based on sensor data obtained by one or more sensors mounted to an exterior of the vehicle, the animal proximate to a planned path for the vehicle;
classifying the animal based on the sensor data and additional data describing the environment of the vehicle;
selecting an action for the vehicle to perform based on the classification of the animal, the action selected to enable the vehicle to traverse the planned path;
performing the selected action by the vehicle;
obtaining additional sensor data, the sensor data including data describing the classified animal; and
determining, based on the additional sensor data, that the vehicle can traverse the planned path.

2. The method of claim 1, wherein the additional data describing the environment of the vehicle comprises at least one of a current time of day and a location of the vehicle.

3. The method of claim 2, further comprising:
retrieving a list of potential animals in the environment of the vehicle based on the additional data; and
classifying the animal based on the list of potential animals.

4. The method of claim 1, wherein classifying the animal based on the sensor data and the additional data describing the environment of the vehicle comprises:
inputting at least a portion of the sensor data and at least a portion of the additional data to a machine-trained classification model; and
receiving data indicating a type of the animal from the machine-trained classification model.

5. The method of claim 1, wherein the action is selected from a set of vehicle actions comprising moving the vehicle towards the animal, moving the vehicle away from the animal, and moving the vehicle in a path around the animal.

6. The method of claim 1, wherein the action comprises making a sound at a specific frequency, the specific frequency selected based on the classification of the animal.

7. The method of claim 1, further comprising:
transmitting data describing the animal and a location of the AV or the animal to a fleet management system, wherein the fleet management system instructs a second vehicle in a fleet to select a route that avoids the animal.

8. A vehicle comprising:
a sensor suite comprising a plurality of sensors mounted to an exterior of the vehicle and to obtain sensor data describing an environment of the vehicle; and
processing circuitry to:
identify an animal in an environment of the vehicle based on the sensor data, the animal proximate to a planned path for the vehicle;
classify the animal based on the sensor data and additional data describing the environment of the vehicle;
select an action for the vehicle to perform based on the classification of the animal, the action selected to enable the vehicle to traverse the planned path;
instruct the vehicle to perform the selected action;
receive additional sensor data from the sensor suite, the sensor data including data describing the classified animal; and
determine, based on the additional sensor data, that the vehicle can traverse the planned path.

9. The vehicle of claim 8, wherein the additional data describing the environment of the vehicle comprises at least one of a current time of day and a location of the vehicle.

10. The vehicle of claim 9, the processing circuitry further to:
retrieve a list of potential animals in the environment of the vehicle based on the additional data; and
classify the animal based on the list of potential animals.

11. The vehicle of claim 8, wherein classifying the animal based on the sensor data and the additional data describing the environment of the vehicle comprises:
inputting at least a portion of the sensor data and at least a portion of the additional data to a machine-trained classification model; and
receiving data indicating a type of the animal from the machine-trained classification model.

12. The vehicle of claim 8, wherein the action is selected from a set of vehicle actions comprising moving the vehicle towards the animal, moving the vehicle away from the animal, and moving the vehicle in a path around the animal.

13. The vehicle of claim 8 further comprising an audio device, wherein the action comprises outputting a sound from the audio device at a specific frequency, the specific frequency selected based on the classification of the animal.

14. The vehicle of claim 8, the processing circuitry further to transmit data describing the animal and a location of the AV or the animal to a fleet management system, wherein the fleet management system instructs a second vehicle in a fleet to select a route that avoids the animal.

15. A non-transitory computer-readable medium storing instructions that, when executed by a processor, cause the processor to:
identify an animal in an environment of a vehicle based on sensor data obtained by one or more sensors mounted to an exterior of the vehicle, the animal proximate to a planned path for the vehicle;
classify the animal based on the sensor data and additional data describing the environment of the vehicle;
select an action for the vehicle to perform based on the classification of the animal, the action selected to enable the vehicle to traverse the planned path;
perform the selected action by the vehicle;
obtain additional sensor data, the sensor data including data describing the classified animal; and
determine, based on the additional sensor data, that the vehicle can traverse the planned path.

16. The non-transitory computer-readable medium of claim 15, wherein the additional data describing the environment of the vehicle comprises at least one of a current time of day and a location of the vehicle.

17. The non-transitory computer-readable medium of claim 16, wherein the instructions further cause the processor to:
retrieve a list of potential animals in the environment of the vehicle based on the additional data; and
classify the animal based on the list of potential animals.

18. The non-transitory computer-readable medium of claim 15, wherein classifying the animal based on the sensor data and the additional data describing the environment of the vehicle comprises:
inputting at least a portion of the sensor data and at least a portion of the additional data to a machine-trained classification model; and
receiving data indicating a type of the animal from the machine-trained classification model.

19. The non-transitory computer-readable medium of claim 15, wherein the action is selected from a set of vehicle actions comprising moving the vehicle towards the animal, moving the vehicle away from the animal, and moving the vehicle in a path around the animal.

20. The non-transitory computer-readable medium of claim 15, wherein the instructions further cause the processor to transmit data describing the animal and a location of the AV or the animal to a fleet management system, wherein the fleet management system instructs a second vehicle in a fleet to select a route that avoids the animal.
